(19) United States
(12) Patent Application Publication
(10) Pub. No.: US 2026/0091700 A1
(43) Pub. Date: Apr. 2, 2026

(54) REAL-TIME ELECTRIC VEHICLE CHARGING DETECTION USING EDGE COMPUTING

(71) Applicant: Utilidata, Inc., Providence, RI (US)

(72) Inventors: Ashley King, East Greenwich, RI (US); Kevin Smith, Portland, OR (US)

(73) Assignee: Utilidata, Inc., Providence, RI (US)

(21) Appl. No.: 19/059,080

(22) Filed: Feb. 20, 2025

Related U.S. Application Data
(60) Provisional application No. 63/700,156, filed on Sep. 27, 2024.

(51) Int. Cl. B60L 53/62; B60L 53/68; H02J 7/04

(52) U.S. Cl. CPC B60L 53/62; B60L 53/68; H02J 7/04

(57) ABSTRACT

This disclosure is directed to real-time electric vehicle charging detection using edge computing. An edge device can receive a time series of aggregated current waveform measurements at the site and determine, based on the measurements, a magnitude of one or more harmonics and a metric. The edge device can generate, based on a baseline for the site, a feature vector based on the magnitude of the one or more harmonics and the metric and determine, using a machine learning model, a probability that an EV is charged at the site during a time window of the measurements. The edge device can transmit, based on a comparison of the probability with a threshold, a notification to cause a remote data processing system to execute an operation related to distribution of electricity via the distribution grid.

### CROSS-REFERENCES TO RELATED APPLICATIONS

This application claims the benefit of priority under 35 U.S.C. § 119 to U.S. Provisional Ser. No. 63/700,156 , filed Sep. 27, 2024, which is hereby incorporated by reference herein in its entirety.

### FIELD OF THE DISCLOSURE

This disclosure relates generally to systems and methods for real-time detection of events impacting electricity distribution on an electrical grid, such as electric vehicle (EV) charging occurrences, according to high-resolution transient data and edge computing.

### BACKGROUND

Utility distribution grids can generate and distribute electric power to various customer sites. The utility distribution grids can supply power via transmission or distribution lines to various loads at the customer sites, such as consumer electric devices or residential charging infrastructures. The utility distribution grids can use meters to observe or measure utility delivery or consumption in the grid.

### BRIEF SUMMARY OF THE DISCLOSURE

Within the utility distribution grids, residential or consumer sites can include infrastructure whose use can impact the grid operation. Such infrastructure can include, for example, stations for charging EVs, solar panels or wind turbines for generating electricity, or industrial machines having large loads, any of which can introduce sudden electrical impact to the grid. For example, as the number of EVs increases, the scale of the charging infrastructures can also increase, potentially resulting in large-scale residential EV charging. Such large-scale residential EV charging can burden the utility grid in ways that were uncommon prior to EV adoption. These changes to the use of the grid can impact the planning or operation of the utility grid when the charging is not orchestrated, such as when the time, duration, amplitude, or other variables are not scheduled or identified. Because EVs utilize large batteries (e.g., 20 to 100 kWh capacity, among other capacities), these batteries can be used as mobile energy storage to support edge devices (e.g., electric devices at the consumer site) or the utility grid. Storing energy in batteries of such size can potentially reduce loads on the utility grid or provide power to other edge devices, such as during power disruption events.

Detecting EV charging in real-time or near real-time (e.g., within 1-5 seconds of the event) can allow for determination of charging characteristics, estimation of the EV penetration or growth rates within the utility grid range, or the determination of the effects of EVs (e.g., EV charging) on the power quality at the edge of a distribution grid, such as at or near a customer site, load, or metering device. The edge of the distribution grid can be referred to as a grid edge. For proper operation of the utility grid, such as preparing, managing, or leveraging the EVs as contributing assets to functionalities of the grid (e.g., supplying electricity from the battery of the EVs to the load), the components of the utility grid can utilize the capabilities associated with detecting EV charging events to determine charging behaviors, effects of the charging events on the system (e.g., utility grid), or growth trajectory of EV charging. However, it can be challenging to detect EV charging in residential areas due to aggregated or mixed signals from the charging infrastructures and other consumer electric devices (e.g., other residential loads), which may be sampled at a relatively low time resolution in certain systems. The technical solutions of the present disclosure can utilize computing resources at the grid edge and communications to remote computing devices (e.g., the cloud) to provide a more effective, reliable, and accurate approach to addressing the challenges in detecting and analyzing EV charging events. For example, the computing resources at the grid edge can be provided by an edge device, which can refer to or include a hardware device (e.g., a computing device with one or more processors and memory) that can process data locally at the edge of the distribution grid, as opposed to having to send the data to a centralized data center that is remote from the end load or customer. An edge device can be referred to or include a grid edge device.

The technical solutions of this disclosure can provide devices (e.g., edge devices, metering devices or other computing systems) configured to perform real-time charging detection to manage or support EV charging via utility control or aggregators (e.g., virtual power plants). The systems and methods of the technical solutions can leverage relatively high-resolution data (e.g., at least 10-50 kHz sampling rate) recorded locally relative to the EV charging location (e.g., recorded by the metering device associated with the respective charging units). The metering devices (which can refer to or include meters) can be configured with the necessary computing power to execute the various operations or computations, and the necessary network bandwidth for data communication to and from at least one remote computing device (e.g., cloud). The systems and methods can process the high-resolution data to obtain statistics or metrics, including harmonic-magnitudes and kurtosis. The systems and methods can utilize the statistics for training a machine learning (ML) model or predicting or determining EV charging events.

An aspect of the technical solutions of this disclosure is directed to a system. The system can include an edge device that includes one or more processors coupled with memory. The edge device can be located at a site that receives electricity via a distribution grid. The edge device can be configured (e.g., via instructions and data stored in memory for execution via the one or more processors) to receive a time series of aggregated current waveform measurements at the site. Aggregated current waveform measurements can refer to or include current waveform measurements that capture the effects of a plurality of different types of loads on current consumption at the site as measured by one or more meters. For example, the aggregated current waveform measurements can include measurements associated with EV charging and non-EV charging loads. The aggregated current waveform measurements can be made by a single meter or multiple meters, and can be an aggregate or combination of signals of EV and other loads. The edge device can be configured to determine, based on the time series of aggregated current, a magnitude of one or more harmonics and a statistical metric. The edge device can be configured to generate, based on a baseline established for the site, a feature vector based on the magnitude of the one or more harmonics and the statistical metric. The edge device can be configured to determine, using one or more models trained with ML, a probability that an EV is being charged at the site during a time window corresponding to the time series of aggregated current waveform measurements. The edge device can be configured to transmit, based on a comparison of the probability with a threshold, a notification to a data processing system remote from the edge device to cause the data processing system to execute an operation related to distribution of electricity via the distribution grid.

The system can include a sensor to generate the time series of aggregated current waveform measurements at a sample rate of at least 10 kHz. The time series of aggregated current waveform measurements can include current delivered to a plurality of different types of loads at the site. The edge device can be configured to perform a transform on the time series of aggregated current to generate the one or more harmonics. At least one of the one or more harmonics can include a primary frequency of 60 Hz. The count of the one or more harmonics can be at least 3 (e.g. up to one, two or three harmonics).

The edge device can be configured to generate the statistical metric using Kurtosis. The edge device can be further configured to determine the baseline based on a percentile value of a value of a feature for the site over the time window. The edge device can be configured to generate the feature vector based on subtracting the baseline from an intermediary feature vector generated based on the magnitude of the one or more harmonics and the statistical metric. The edge device can be configured to generate the feature vector based on dividing by a standard deviation of the value of the feature for the site.

The feature vector can include a phase of the one or more harmonics, the magnitude of the one or more harmonics, and the statistical metric. The one or more models can be trained with ML that can include at least one of a decision tree, neural network, a matched filter, a transformer network, or long short-term memory. The edge device can be configured to receive the one or more models from the data processing system located remote from the edge device.

The edge device can be configured to update the one or more models based on the time series of aggregated current. The edge device can be configured to transmit the updated one or more models to the data processing system to cause the data processing system to deploy a second one or more models trained based at least in part on the updated one or more models received from the edge device. The edge device can be configured to select features to include in the feature vectors based on a type of the site. The type of the site can be one of residential, commercial, urban, or rural.

The edge device can be configured to determine to transmit the notification based on the probability being greater than or equal to the threshold to indicate that the EV is being charged at the site. The operation executed by the data processing system comprises at least one of: an instruction to control delivery of power from a distributed energy resource, an instruction to control charging of the EV, an instruction to impact a rate related to power, or an instruction to impact power quality.

An aspect of the technical solutions of this disclosure is directed to a method. The method can include receiving, by an edge device comprising one or more processors coupled with memory, a time series of aggregated current waveform measurements at a site. The time series of current waveform measurements can capture the effects of a plurality of different types of loads on current consumption at the site as measured by one or more meters. For example, the current waveform measurements can capture the current measurements resulting from EV charging and non-EV charging loads. The edge device can be located at the site that receives electricity via a distribution grid. The method can include the edge device determining, based on the time series of aggregated current, a magnitude of one or more harmonics and a statistical metric. The method can include generating, based on a baseline established for the site, a feature vector based on the magnitude of the one or more harmonics and the statistical metric. The method can include the edge device determining, using one or more models trained with ML, a probability that an EV is being charged at the site during a time window corresponding to the time series of aggregated current waveform measurements. The method can include the edge device transmitting, based on a comparison of the probability with a threshold, a notification to a data processing system remote from the edge device to cause the data processing system to execute an operation related to distribution of electricity via the distribution grid.

The method can include generating, by a sensor communicatively coupled with the edge device, the time series of aggregated current waveform measurements at a sample rate of at least 10 kHz. The time series of aggregated current waveform measurements can include current waveforms delivered to a plurality of different types of loads at the site. The method can include generating, by the edge device, the statistical metric using Kurtosis.

The method can include the edge device receiving, the one or more models from the data processing system located remote from the edge device. The method can include updating, by the edge device, the one or more models based on the time series of aggregated current waveforms. The method can include transmitting, by the edge device, the updated one or more models to the data processing system to cause the data processing system to deploy a second one or more models trained based at least in part on the updated one or more models received from the edge device. The method can include selecting, by the edge device, features to include in the feature vectors based on a type of the site, wherein the type of the site is one of residential, commercial, urban, or rural.

An aspect of the technical solutions disclosed herein is directed to a non-transitory computer-readable medium storing processor-executable instructions. The instructions, when executed by one or more processors, can cause the one or more processors to receive a time series of aggregated current waveform measurements at a site. The aggregated current waveform measurements can capture the effects of a plurality of different types of loads on current consumption at the site as measured by one or more meters. The instructions, when executed by one or more processors, can cause the one or more processors to determine, based on the time series of aggregated current waveforms, a magnitude of one or more harmonics and a statistical metric. The instructions, when executed by one or more processors, can cause the one or more processors to generate, based on a baseline established for the site, a feature vector based on the magnitude of the one or more harmonics and the statistical metric. The instructions, when executed by one or more processors, can cause the one or more processors to determine, using one or more models trained with ML, a probability that an EV is being charged at the site during a time window corresponding to the time series of aggregated current waveform measurements. The instructions, when executed by one or more processors, can cause the one or more processors to transmit, based on a comparison of the probability with a threshold, a notification to a data processing system remote from the one or more processors to cause the data processing system to execute an operation related to distribution of electricity via a distribution grid.

This disclosure is directed to a system for real-time detection of EV charging. The system can include a metering system, comprising one or more processors and memory, located on a utility grid downstream from a substation to: receive high-resolution electrical data, generate a first plurality of statistics according to the high-resolution electrical data, train a ML model using the first plurality of statistics, and predict, using the trained ML model, an EV charging event based on a second plurality of statistics.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with some implementations;

FIG. 2 is a block diagram illustrating an example system for real-time detection of EV charging, in accordance with some implementations;

FIG. 3 is a block diagram of an example system for real-time electricity distribution event detection, in accordance with some implementations;

FIG. 4 illustrates a bar graph of example current Fast Fourier Transform (FFT) spectrum harmonic magnitudes, in accordance with some implementations;

FIG. 5 is a block diagram illustrating an example EV detection training stage, in accordance with some implementations;

FIG. 6 is a block diagram illustrating an example EV detection inference stage, in accordance with some implementations; and

FIG. 7 is a block diagram illustrating an architecture for a computer system that can be employed to implement elements of the systems and methods described and illustrated herein, including, for example, aspects of the utility grid depicted in FIG. 1, the system of FIG. 2-3, and the operations of FIGS. 5-6.

FIG. 8 is a flow diagram of a method for providing a real-time detection of EV charging, in accordance with some implementations.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of real-time detection of electricity distribution events, such as EV charging events. The various concepts introduced above and discussed in greater detail below may be implemented in any of numerous ways.

The technical solutions of this disclosure can be directed to systems and methods for real-time detection of electricity distribution events on a grid, such as EV charging events, based on high-resolution transient data and edge computing. Managing large-scale electricity distribution events, such as multiple EV charging events, and their impact on a residential grid, can be a challenge. As the number of EVs increases, the scale of charging infrastructures also grows and becomes more demanding, potentially leading to excessive loads on the utility grid. This can impact performance, the operations as well as the planning of the grid, especially when charging events are not orchestrated or identified in real-time. Detecting such power demanding electricity distribution events, such as EV charging events, in residential areas is particularly hard due to the aggregated or mixed signals from various consumer devices consuming power simultaneously. The challenges can be even further compounded when systems provided monitor the state of the grid using samples that are at relatively low time resolutions, making it challenging to detect transient events.

To overcome these issues, the technical solutions can utilize devices, such as edge devices or metering devices, to perform real-time charging detection using high-resolution data (at least 10-50 kHz sampling rate) recorded locally relative to the EV charging location. The solutions can utilize edge devices to receive a time series of aggregated current waveform measurements at the site and determine, based on this data, the magnitude of one or more harmonics and a statistical metric. The edge devices can then generate a feature vector based on a baseline established for the site and use ML models to determine the probability of an EV charging event. By transmitting a notification to a remote data processing system based on a comparison of this probability with a threshold, the system can execute operations related to the distribution of electricity via the distribution grid, effectively managing and supporting EV charging events.

The systems and methods of the technical solution discussed herein can detect charging events to manage the charging of EVs or other machines or devices using the charging infrastructures. The systems and methods can include real-time energy or power management and control applications to provide relatively high-frequency control or power balancing. The systems and methods can leverage relatively high-resolution data (e.g., at least 10-50 kHz sampling rate) recorded locally relative to the EV charging location (e.g., recorded by the metering device associated with the respective charging units). The systems and methods can process the high-resolution data to obtain statistics or metrics, including at least harmonic-magnitudes and kurtosis. The systems and methods can utilize the statistics for training a ML model or predicting or determining EV charging events. The features or operations can be executed on the metering device or a remote computing device, such as a computing or data processing device external to or at a location remote from the metering device.

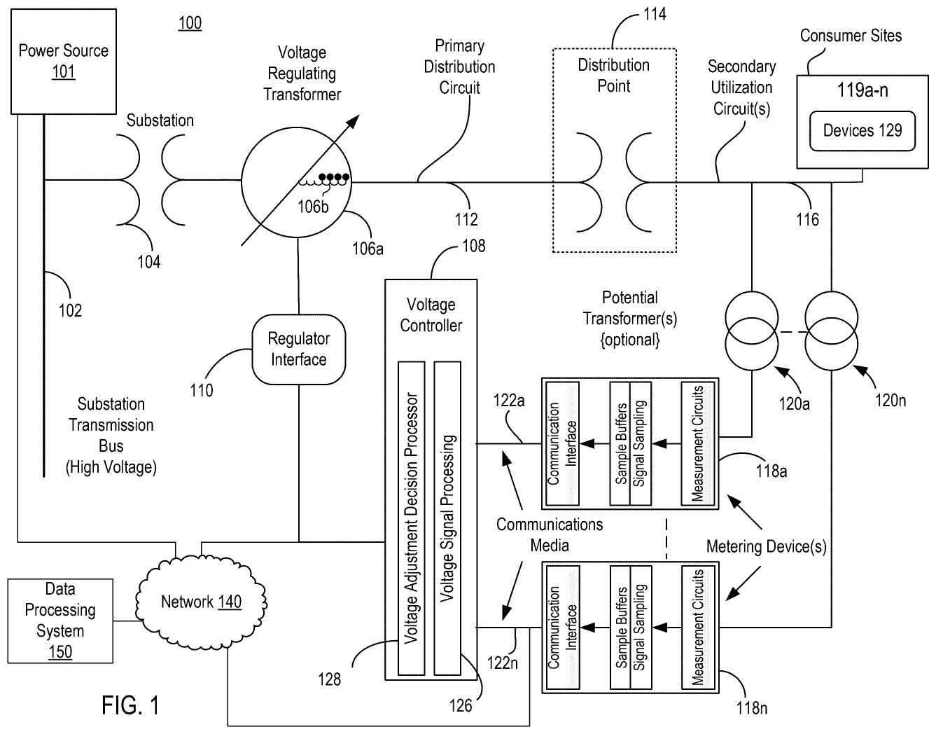

FIG. 1 depicts an example utility distribution environment. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102 or via substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 129, which can be located at sites 119. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 129 at a site 119, connected to circuit 112 or 116 from a power source 101 coupled to bus 102. These metering devices 118a-118n, among other components within utility distribution grids, can collect samples of power delivery or consumption, such as voltage information, at a predetermined sample rate. A voltage controller 108 can receive, via a communication media 122, measurements obtained by the metering devices 118a-118n and use the measurements to make a determination regarding a voltage tap settings, and provide an indication to regulator interface 110. The regulator interface can communicate with voltage regulating transformer 106a to adjust an output tap level 106b.

In FIG. 1, in further detail, the utility grid 100 includes a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage alternating current (AC) and direct current (DC) systems and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transform voltage from high to low, or the reverse, or performs any of several other functions to facilitate the distribution of electricity. In some embodiments, the utility grid 100 can include several substations 104 between the power plant 101 and the consumer electoral devices 129 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an AC power distribution system and the term voltage can refer to a root mean square (RMS) voltage, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers or their sites 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises or site 119. Distribution transformers can further lower the voltage to the utilization voltage of appliances and can feed several customers at site 119 through secondary distribution lines or circuits 116 at this voltage. Commercial and residential customers or their sites 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition or event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 129 at sites 119. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor-controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 129 at sites 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include Advanced Mobile Phone System (AMPS), Global System for Mobile Communications (GSM), General Packet Radio Service (GPRS), Universal Mobile Telecommunications System (UMTS), Long Term Evolution (LTE), LTE Advanced, Mobile WiMAX, and WiMAX-Advanced. Cellular network standards can use various channel access methods e.g. Frequency Division Multiple Access (FDMA), Time Division Multiple Access (TDMA), Code Division Multiple Access (CDMA), or Spatial Division Multiple Access (SDMA). In some embodiments, different types of data can be transmitted via different links and standards. In other embodiments, the same types of data can be transmitted via different links and standards.

The network 140 can be any type or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the internet protocol suite (TCP/IP), the Asynchronous Transfer Mode (ATM) technique, the Synchronous Optical Networking (SONET) protocol, or the Synchronous Digital Hierarchy (SDH) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 700 or a portion of computing device 700 or some or all functionality of computing device 700.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuity (e.g., a central processing unit or CPU) that responds to and processes instructions fetched from a memory unit (e.g., memory 715 or storage device 725). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150.

The data processing system 150 can obtain measurements (e.g., raw or processed data or electric waveforms) from the one or more metering devices 118 within the utility grid 100. The data processing system 150 can receive or obtain the measurements from the metering devices 118 in response to each metering device 118 performing the measurement. The data processing system 150 may receive an aggregate of the measurements from the metering devices 118. The aggregate of measurements can, in some cases, refer to measurements coming from multiple current waveforms of multiple current “legs”. However, in some cases, the aggregate of measurements can refer to a single current waveform that is measured that captures the effects of multiple loads on current consumption. For example, the single current waveforms measurements can be an aggregate of or a combination of the current consumption due to EV charging and non-EV charging loads. The term aggregated current waveform measurements can refer to or include a single time series of current waveform measurements that captures the effects of current consumption by multiple loads or different types. In some cases, the term aggregated current waveform measurements can refer to or include multiple time series of current waveform measurements corresponding to different current “legs” that are aggregated or combined into one or more time series of aggregated current waveform measurements. The aggregated current waveform measurements can be made by a single metering device or multiple metering devices. In either case, each metering device 118 may store the measurements in a local memory and send the data in response to at least one of a predetermined time interval for a scheduled transmission, receiving a request for data from the data processing system 150, or a predetermined duration, size, or amount of data samples is collected. In some cases, the metering devices 118 can process the data prior to transmitting the data to the data processing system 150.

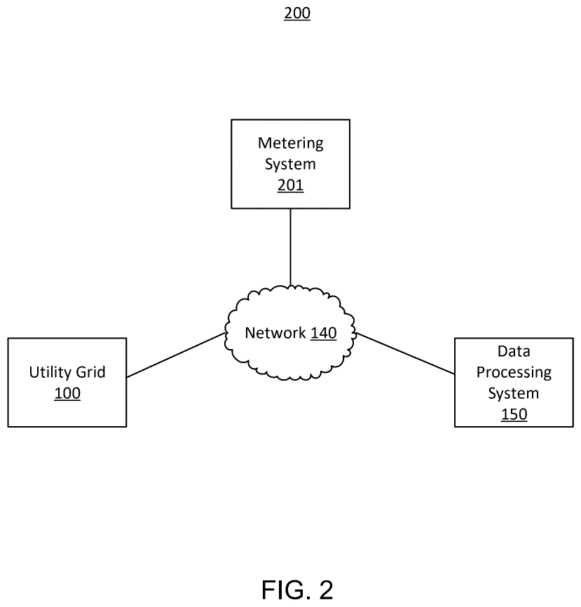

FIG. 2 depicts a block diagram illustrating an example system 200 for real-time detection of EV charging. The system 200 can include, interface with, access, or otherwise communicate with at least one utility grid 100, at least one data processing system 150, and at least one metering system 201. The metering system 201 can include one or more components (e.g., one or more processors, memory, databases, interfaces, etc.) configured to perform features or functionalities discussed herein for detection or prediction of EV charging (e.g., occurrences or events of EV charging) or managing the utility grid 100. The metering system 201 can include or correspond to one or more metering devices 118 located in the utility grid 100. In some cases, the metering system 201 can be a computing device local to or remote from the utility grid 100 or the data processing system 150. In some other cases, the metering system 201 can be a part of or perform one or more functionalities same as or similar to the data processing system 150. The metering system 201 can transmit or receive data to or from other components (e.g., utility grid 100 or data processing system 150) of the system 200 via the network 140. The utility grid 100 and the network 140 can be referred to in conjunction with FIG. 1. The one or more devices, components, or systems (e.g., data processing system 150, metering system 201 (or metering devices 118), etc.) of the utility grid 100 or the system 200 can be composed of hardware, software, or a combination of hardware and software components.

The metering system 201 can include or correspond to at least one metering device 118, such as one of the metering devices 118 configured to perform one or more features (e.g., collect and process electricity characteristics) for EV charging detection or prediction. The metering system 201 can be located within the utility grid 100. For example, the metering system 201 can be positioned, installed, or provided at a location downstream from the substation 104 on the utility grid 100 that distributes electricity, e.g., at the edge of the utility grid 100 (e.g., grid edge) or at the EV charging location (e.g., residential or commercial areas). Other metering systems can be distributed or installed throughout the utility grid 100, configured to perform one or more features or functionalities similar to the metering system 201. In various cases, the metering systems (including the metering system 201) can correspond to or include edge devices within the utility grid 100. For purposes of providing examples, the features or operations discussed herein to detect, determine, or predict EV charging events can be performed by the metering system 201 (or the metering device 118), although other devices or systems (at the grid edge) can be configured to perform the EV charging detection, not limited to the metering system 201.

The metering system 201 can receive and process data locally on the utility grid 100. In some cases, the metering system 201 can forward or delegate one or more features or functionalities to another computing device local to or remote from the utility grid 100. For instance, the metering system 201 can transmit data to the data processing system 150 executing in a cloud computing environment or distributed computing environment. In this case, the metering system 201 may perform a portion of the functionalities for processing information (e.g., electrical characteristics) local to the utility grid 100 and the data processing system 150 may perform another portion of the functionalities for processing the information (or processed data from the metering system 201). Certain other features or functionalities of the metering system 201 may be performed by the data processing system 150 (or other devices), such as performing real-time energy or power management for the utility grid 100, presenting EV detection or prediction results to operators or users, or executing other actions using data from the metering system 201. In some aspects, the metering system 201 can perform the various operations discussed herein and the results (e.g., detection or prediction of EV charging event(s)) can be communicated to the data processing system 150.

The metering system 201 can obtain or collect electrical data within the utility grid 100. The electrical data can include data samples of an electrical waveform corresponding to electricity (e.g., electrical signals) distributed at or to the location of the metering system 201 on the utility grid 100. For example, the metering system 201 can collect electrical data in residential areas (e.g., residential homes), such as to measure the electricity consumed or drawn at the consumer site 119. The residential home may include at least one EV charger. In various cases, the metering system 201 can receive or obtain relatively high-resolution data, such as at least 10 kHz, 30 kHz, or 50 kHz of current or voltage data. The metering system 201 can obtain the electrical data (or electricity data) at a resolution of greater than 10 kHz. In various cases, the electrical data discussed herein can be at least one of voltage data, current data, or power data, among other types of electrical information.

For example, the metering system 201 can obtain electrical waveform data (e.g., voltage waveform data or current waveform data) corresponding to electricity consumed by at least one load within the utility grid 100 and measured by at least one of the metering devices 118. The measured electricity (e.g., voltage measurement or current measurement) can represent or indicate the electrical consumption at the consumer site 119 (or residential home). In some cases, the metering system 201 can correspond to the metering device 118 located at the grid edge, and can include one or more sensors (e.g., current sensors or voltage sensors) to detect or measure the electricity (e.g., voltage or current) distributed over the utility grid 100. Metering system 201 can include one or more of harmonics determiner 302, vector generator 312, event determiner 312, notification function 340 of ML framework 350. Metering system 201 can be comprised within one or more edge devices 301. In some other cases, the metering system 201 can be in communication with the metering device 118 via the network 140, to obtain the electrical data from the metering device 118. For purposes of providing examples, the metering system 201 can process the current data for EV charging detection and prediction, although other electrical data (e.g., voltage data) can be utilized for perform the detection or prediction.

The metering system 201 can compute or determine a plurality of harmonics in, kurtosis of, or other statistics or metrics according to the measured electricity data (e.g., current waveform). The electricity data can be in a digitized time series including a sequence of data points, e.g., electricity value or measurement, converted into a digital format. For example, the metering system 201 can process the digitized electrical data, such as current waveform time series, to obtain desired statistics of (or representing) electricity consumption at the site. The statistics can include at least one of, but not limited to, harmonic magnitudes and kurtosis.

The metering system 201 can compute the harmonic magnitudes by using FFT of the electrical (e.g., current) waveform time series. The metering system 201 can use FFT to convert a time-domain signal (e.g., current waveform) into its frequency-domain representation for identification of the harmonics of the electrical waveform according to the repeated frequency components present in the time-domain signal. For example, the metering system 201 can apply FFT to the input time series (e.g., current waveform time series). Applying the FFT to the time series can transform the (current) data from the time domain to the frequency domain, e.g., converting the signal into the associated constituent sinusoidal components (e.g., frequencies). The output of the FFT can include a frequency spectrum indicating the amplitude of different frequency components present in the electrical signal. Peaks in the frequency spectrum can correspond to the fundamental frequency (e.g., the main oscillation) and the harmonics of the electrical signal. Based on the peaks in the frequency spectrum, the metering system 201 can identify the fundamental frequency (e.g., primary frequency with increment or decrement of 60 Hz) and its associated harmonics, including at least one of but not limited to the 2^{nd} harmonic, 3^{rd} harmonic, 5^{th} harmonic, etc. In various cases, the harmonics can represent the amplitudes of the FFT outputs (e.g., frequency spectrum). A harmonic can be any integer multiple of a fundamental frequency present in the current waveforms, such as a frequency that is an integral multiple of a fundamental frequency of the signal measured.

The metering system 201 can be configured to use predefined harmonic orders selected by the user or configured by the operator of the utility grid 100. For example, the metering system 201 can use odd harmonic orders, including one or more of 1^{st} harmonic, 2^{nd} harmonic, 3^{rd} harmonic, 5^{th} harmonic, 7^{th} harmonic, 9^{th} harmonic. 45^{th} harmonic, 47^{th} harmonic, or 49^{th} harmonic, among others. With the high-resolution data, e.g., including a frequency range of 10 kHz to 50 kHz, at least three cycles of the 49^{th} harmonic magnitude can be obtained for a desired amount of signal-to-noise ratio to measure the magnitude. In another example, the metering system 201 can use even harmonic orders, including one or more of 2^{nd} harmonic, 4^{th} harmonic, 6^{th} harmonic, 8^{th} harmonic. 44^{th} harmonic, 46^{th} harmonic, or 48^{th} harmonic, among others. The metering system 201 may use a combination of odd and even harmonics. The metering system 201 can use any other harmonic orders or combinations of harmonic orders.

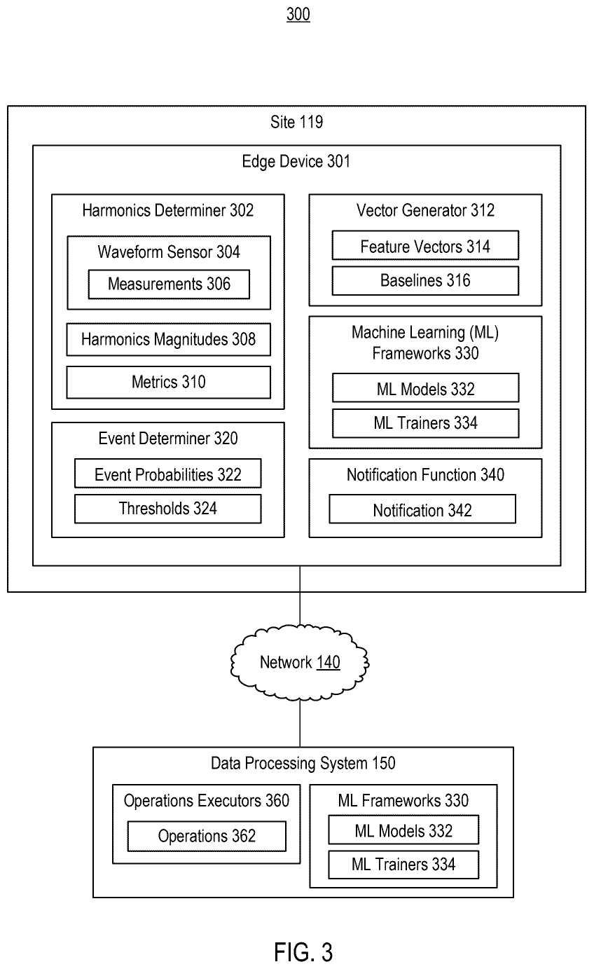

FIG. 3 illustrates a block diagram of an example system 300 for real-time detection of electricity distribution events (e.g., EV charging events) occurring on an electric grid 100. For example, the system 300 can be a system for real-time charging detection of EV charging events on one or more sites 119 of a grid 100. The system 300 can include a site 119 that can receive or provide electricity via a distribution grid 100. The site 119 can include one or more edge devices 301 that can be communicatively coupled with a data processing system 150, via a network 140. An edge device 301 can include one or more of harmonics determiners 302, vector generators 312, event determiners 320, ML frameworks 330 and notification functions 340. A data processing system 150 can include one or more of operations executors 360 and ML frameworks 330.

The harmonics determiner 302 of an edge device 301 can include one or more waveform sensors 304 to generate, implement or receive measurements 306 (e.g., time series of aggregated current waveform measurements) and determine (e.g., based on the measurements 306) one or more harmonics magnitudes 308 and metrics 310 (e.g., magnitudes of harmonics and statistical metrics of the aggregated current waveform measurements). The vector generator 312 of the edge device 301 can be configured to generate, based on the determined harmonic magnitudes 308 and the metrics 310, one or more feature vectors 314 based on, or using, one or more established baselines 316 for the given site 119. The edge device 301 can include one or more ML frameworks 330 that can include ML models 332 trained using one or more ML trainers 334, or can receive ML models 332 from a ML framework 330 on a data processing system 150. An event determiner 320 of the edge device 301 can utilize one or more ML models 332 to determine an event probability 322 that a particular event (e.g., a charging of an EV) is occurring at the site 119 during a time window corresponding to the time series of the aggregated current waveform measurements 306. For instance, the event determiner 320 can determine that an electricity distribution event (e.g., a charging of an EV) is occurring based on the event probability 322 satisfying a threshold 324 for that probability. A notification function 340 can transmit a notification 342 (e.g., when the event probability 322 satisfies a threshold 324) to a data processing system 150. The notification 342 can cause the data processing system 150 to utilize an operations executor 360 to execute or trigger one or more operations 362 related to distribution of electricity via the distribution grid 100.

Across the network 140, a data processing system 150 can include or execute one or more operations executors 360 for performing operations 362. The data processing system 150 can include one or more ML frameworks 330 that can include one or more ML models 332 that are trained via one or more ML trainers 334. In some implementations, the ML framework 330 of the data processing system 150 can implement the training of the ML models 332 and can provide or update the trained ML models 332 to the edge devices 301.

An edge device 301 can be any combination of hardware and software for processing and analyzing electrical data at a site that receives electricity via a distribution grid. The edge device 301 include, or be deployed on, a metering system 201 and include any functionalities of a metering system 201, and vice versa. The edge device 301 can include one or more processors coupled with memory to execute various operations. For example, the edge device 301 can receive a time series of aggregated current waveform measurements 306 at the site and determine harmonic magnitudes and statistical metrics 310 based on these measurements. An aggregated current waveform can be any combination of electrical current measurements from one or more (e.g., multiple) loads at a site 119, summed together to provide a comprehensive view of the total current flow over time. The loads can be different types of loads, including, for example, EV charging loads and non-EV charging loads. The edge device 301 can generate feature vectors 314 using established baselines 316 for the site 119 and utilize ML models 332 to predict the event probability 322 that a particular EV charging event is taking place during the time period of the time series waveform measurements taken by the waveform sensor 304. The edge device 301 can transmit notifications to a remote data processing system to execute operations related to electricity distribution. The edge device 301 can also update ML models 332 based on new data and receive updated models from the remote data processing system 150.

Harmonics determiner 302 can include any combination of hardware and software for analyzing electrical waveforms (e.g., measurements 306) to determine harmonic magnitudes 308 or metrics 310. The harmonics determiner 302 can use one or more waveform sensors 304 to generate or receive measurements 306, such as time series of aggregated current waveform measurements, which can take or generate time series of aggregated current waveform measurements at a particular sample rate (e.g., between 1 kHz and 100 kHz, such as 10 or 20 kHz). For example, a harmonics determiner 302 can perform a transform on the time series of aggregated current waveforms to generate harmonic magnitudes, including primary frequencies like 60 Hz and other harmonics. For example, a harmonics determiner 302 can perform a transform on the time series of aggregated current waveforms to generate harmonic magnitudes, including primary frequencies like 60 Hz and other harmonics. The transforms can include FFT for frequency domain analysis, Wavelet Transform for time-frequency analysis or Short-Time Fourier Transform (STFT) for analyzing non-stationary signals.

The harmonics determiner 302 can calculate statistical metrics, including, for example, kurtosis to measure the sharpness of the waveform distribution, skewness to assess the asymmetry of the waveform, standard deviation to quantify the amount of variation or dispersion in the waveform, or mean absolute deviation to measure the average absolute deviation from the mean of the waveform. The harmonics determiner 302 can utilize kurtosis to analyze or describe the distribution of data around the mean, such as the sharpness of the peak of a frequency-distribution curve or the shape of the waveform distribution. The harmonic magnitudes 308 and metrics 310 can be used to generate feature vectors 314 (e.g., based on the baseline 316 operation or metrics of the site 119) to determine or indicate occurrence of specific electricity distribution events, such as EV charging events. The harmonics determiner 302 can be configured to handle or determine harmonics magnitudes 308 or metrics 310 for various types of loads and electrical environments, including for example, EV charging events, utilization of residential appliances or industrial machinery, energy provided by renewable energy sources, such as solar panels and wind turbines, usage of HVAC systems or commercial lighting or other systems.

Waveform sensor 304 can be any type of sensor for generating or receiving electrical waveform measurements. The waveform sensor 304 can be configured to sample current waveforms at high resolutions, such as at least 10 kHz. For example, the waveform sensor 304 can generate a time series of aggregated current waveform measurements that include current waveforms delivered to different types of loads at the site. The waveform sensor 304 can provide these measurements to the harmonics determiner 302 for further analysis. The waveform sensor 304 can be integrated into the edge device 301 or operate as a separate component. The high-resolution data generated by the waveform sensor 304 can be used for accurate detection of EV charging events.

Measurements 306 can be any type and form of electrical signals or data received, monitored, measured or collected by the waveform sensor 304. The measurements 306 can include time series of aggregated current waveform measurements sampled at resolutions, such as at between 1 kHz and 100 kHz, such as 10 kHz. For example, the measurements 306 can represent current waveforms delivered to various loads at the site, including residential and commercial loads. The measurements 306 can be used by the harmonics determiner 302 to calculate harmonic magnitudes 308 and statistical metrics 310, which can be used to provide or determine insights into electrical consumption at a site 119. The high-resolution nature of the measurements 306 can allow for accurate detection and analysis of high energy events, such as EV charging events, events in which large industrial machinery is turned on or utilized or events involving solar farms providing power to the grid.

Harmonics magnitudes 308 can be any type and form of data representing the amplitude of harmonic components in the electrical waveform. The harmonics magnitudes 308 can be determined by performing a transform, such as an FFT, on the time series of aggregated current waveforms. The harmonics magnitudes 308 can be determined using Wavelet Transform for analyzing localized variations of power within a time series, Short-Time Fourier Transform (STFT) for examining non-stationary signals, or Hilbert Transform for obtaining the analytic signal and instantaneous frequency. For example, the harmonics magnitudes 308 can include primary frequencies like 60 Hz and other harmonics, such as the 2nd, 3rd, 4^{th}, and 5th harmonics. These magnitudes can be used to generate feature vectors 314 for further analysis. The harmonics magnitudes 308 can provide valuable information about the electrical characteristics at the site. The harmonics magnitudes 308 can be used to detect anomalies and detect or predict the scheduled timing of power distribution events, such as EV charging events, industrial machinery utilization events or energy generation system (e.g., solar or wind farm) power providing events.

Metrics 310 can be any type and form of statistical data calculated from the electrical waveform measurements. The metrics 310 can include statistical measures such as kurtosis, which indicates the shape of the waveform distribution, such as how much the tails of the distribution differ from the tails of a normal distribution. For example, kurtosis can help identify whether the waveform has heavy tails or outliers, which can be indicative of transient events. For instance, metrics 310 can include skewness to assess the asymmetry of the waveform, as well as standard deviation or variance to quantify the amount of variation or dispersion in the waveform. Metrics 310 can include mean absolute deviation, can include measurements of the average absolute deviation from the mean of the waveform. The metrics 310 can include the root mean square (RMS) value to assess the magnitude of the waveform. For example, the metrics 310 can be used to detect anomalies, such as transient events and spikes, in the electrical signal. The metrics 310 can be combined with harmonic magnitudes to generate feature vectors for further analysis. These metrics can provide insights into the stability and variability of the electrical signal at the site. The metrics 310 can be crucial for accurate detection and prediction of EV charging events.

Vector generator 312 can include any combination of hardware and software for generating feature vectors based on harmonic magnitudes and statistical metrics. The vector generator 312 can use established baselines for the site to create feature vectors that represent the electrical characteristics at the site. For example, the vector generator 312 can generate a feature vector by subtracting a baseline from an intermediary feature vector generated based on harmonic magnitudes and statistical metrics. The vector generator 312 can adjust or standardize the feature vector by dividing by the standard deviation of the feature values. The feature vectors 314 can be used by ML models to predict power distribution events on the grid, such as EV charging events at a site 119. The vector generator 312 can handle various types of electrical environments and loads.

Feature vector 314 can be any type and form of data representing the electrical characteristics at one or more sites 119. The feature vector 314 can be generated based on or correspond to harmonic magnitudes 308 and statistical metrics 310 and can be determined based on or using established baselines 316 for a specific site 119. For example, the feature vector 314 can include the phase and magnitude of harmonics or statistical metrics, such as kurtosis. The feature vector 314 can be standardized by dividing by the standard deviation of the feature values. The feature vectors 314 can be used by ML models to predict the probability of an electricity distribution event, such as an EV charging event, usage of a particular large industrial machinery, or providing of power by an energy generating system (e.g., wind turbine or solar farm). The feature vector 314 can provide a comprehensive representation of the electrical characteristics at the site 119. For instance, the feature vector 314 can represent electrical characteristics using a magnitude of the vector in a multidimensional space. (e.g., space defined by feature variables, such as phase and magnitude of harmonics or statistical metrics such as kurtosis and skewness), which can provide a measure of the overall intensity or strength of the combined features. For example, if the feature vector 314 includes high values for harmonic magnitudes 308 and statistical metrics 310, the magnitude of the vector can be larger, indicating a stronger or more pronounced electrical event. The magnitude can be calculated using a Euclidean norm, which involves taking the square root of the sum of the squares of the individual feature values, which can provide a single scalar value representing the overall size of the feature vector.

Baseline 316 can be any type and form of reference data used to generate feature vectors. The baseline 316 can be a plot or a graph of data over a range, such as a time range or electricity range. The baseline 316 can be established based on historical data for a site 119, such as a percentile value of a feature (e.g., electricity consumption) over a time window. For example, the baseline 316 can represent an average, median or expected (e.g., normal) behavior of an electrical signal at a site 119 for a given time period or interval. The vector generator 312 can use the baseline 316 to create feature vectors 314 by subtracting the baseline from intermediary feature vectors 314. The baseline 316 can help to filter out non-charging periods and highlight deviations from the normal or expected behavior, providing an output of the deviating portion of the data indicative of an electricity distribution event that is outside of standard, normal or average electrical use (e.g., EV charging event). The baseline 316 can be used for improved or accurate detection and prediction of EV charging events.

Event determiner 320 can include any combination of hardware and software for predicting the probability of an EV charging event. The event determiner 320 can use ML models 332 to analyze feature vectors and determine event types or event probabilities. For example, the event determiner 320 can predict the probability that an EV is being charged at the site 119 during a time window corresponding to the time series of aggregated current waveform measurements. For example, the event determiner 320 can utilize ML models 332 to determine a particular type of event taking place during the time series of the measurements. This determination can be made, for example, based on the harmonics magnitudes 308, metrics 310 or feature vectors 314 input into the one or more ML models 332 trained to detect or distinguish between different types of events. The event determiner 320 can compare the event probability 322 with a threshold 324 to determine whether to transmit a notification. The event determiner 320 can process various types of electrical environments and loads, such as powering of one or more residential homes with multiple appliances, providing electricity to one or more commercial buildings with HVAC systems, turning on industrial facilities with heavy machinery, receiving energy from renewable energy sources such as solar panels and wind turbines, EV charging stations charging one or more EVs, and powering urban infrastructure with mixed-use electrical loads. The event determiner 320 can provide real-time predictions of EV charging events.

Events determined by the event determiner 320 can include any type of occurrence or activity involving electricity distribution (e.g., charging or discharging) that can be detected and analyzed by the system. An event can be characterized by specific patterns or anomalies in the electrical waveform data collected at the site. For example, an EV charging event can be detected based on the unique electrical signature of an EV being charged, such as a sudden increase in current draw for a particular amount of energy corresponding to an EV, with specific harmonic patterns corresponding to an EV charging event, and the presence of high-frequency components associated with the charging process of an EV. For example, events can include the operation of residential appliances, such as refrigerators, washing machines, and air conditioners, which can have distinct electrical patterns involving harmonics or current draw amounts. For example, industrial events, such as the startup or shutdown of heavy machinery (e.g., bulldozers, excavators, cranes, forklifts, industrial presses and other devices), can be detected based on their impact on the electrical waveform. For instance, events related to renewable energy sources, such as the activation of solar panels or wind turbines, can be identified by their characteristic electrical signatures. Commercial events, such as the operation of HVAC systems in office buildings, can be detected based on their specific electrical consumption patterns or harmonics. Various systems and their corresponding charging or discharging events can have harmonics indicative of the type of machinery, systems or devices being involved in the event, allowing for their detection and system processing and adjustment.

Event probabilities 322 can be any type and form of data representing the likelihood of an EV charging event. The event probabilities 322 can be determined by ML models based on feature vectors. For example, the event probabilities 322 can indicate the probability that an EV is being charged at the site during a specific time window. Event probabilities 322 can be provided in the range of values, such as a range of values between 0 and 1, the 0 indicating no probability and the 1 indicating certainty that event has occurred. For instance, event probability of 322 of 0.72 can correspond to a value of 72% that an event has occurred. The event probability 322 can be compared with thresholds 324 for the given event to determine whether to take action, such as transmit notifications 342 to data processing system 150 to take action (e.g., trigger operations 362 on the grid 100 to adjust electricity distribution in response to the event). The event probabilities 322 can provide valuable insights into the likelihood of EV charging events. The event probabilities 322 can be used to trigger operations 362 related to electricity distribution, such as actions to control the delivery of power from a distributed energy resource, adjust the charging rate of an EV, manage the load balancing across the grid, initiate demand response programs, and optimize power quality.

Thresholds 324 can be any type and form of reference values used to determine whether to transmit notifications. The thresholds 324 can be compared with event probabilities 322 to decide whether an electricity event (e.g., EV charging event) is occurring. For example, if the event probability 322 is greater than or equal to the threshold 324, a notification function 340 can generate a notification 342 for transmission to a remote data processing system 150 to take action. The thresholds 324 can be configured based on the specifications of the site 119 or the type of event and the electrical environment. The thresholds 324 can help to filter out false positives and ensure accurate detection of EV charging events. The thresholds 324 can correspond to or be used for triggering appropriate operations 362 related to electricity distribution, such as adjusting the power supply to balance the load, initiating demand response actions to reduce peak demand, controlling the charging rate of EVs, activating backup power sources, or optimizing the distribution of renewable energy sources like solar and wind power.

ML framework 330 can include any combination of hardware and software for training and deploying ML models 332. For example, the ML framework 330 can include a set of tools, libraries, or resources that facilitate training, tuning, updating, or deploying ML models. The ML framework 330 can be deployed on a data processing system 150 and can be utilized to provide ML models 332 to the edge devices 301. In some implementations, edge devices 301 can include the ML framework 330 along with the ML models 332 and the ML trainers 334. The ML framework 330 can include ML models 332 trained using one or more ML trainers 334. For example, the ML framework 330 can train ML models 332 using labeled datasets and feature vectors generated from harmonic magnitudes and statistical metrics. The ML framework 330 can deploy trained models to the edge device 301 for real-time prediction of EV charging events. The ML framework 330 can also update models based on new data and receive updated models from a remote data processing system. The ML framework 330 can handle various types of ML techniques, such as decision trees, neural networks, and transformer networks.

ML functionalities can play a role in implementing actions related to real-time detection of electricity distribution events (e.g., EV charging events). Various types of ML models 332 can be utilized, including decision trees, neural networks, matched filters, transformer networks, and long short-term memory (LSTM) models. ML models 332 can be trained using labeled datasets that include feature vectors generated from harmonic magnitudes and statistical metrics. For example, decision trees can be used to classify events based on predefined rules for the events or predefined thresholds 324. For example, neural networks can be used to learn complex patterns in the data to improve prediction accuracy. Matched filters can be employed to detect specific signal patterns associated with EV charging events. Transformer networks can be used to process or handle sequential data and capture long-range dependencies, allow for analyzing time series data to discern or detect types of events based on input measurements 306, harmonics magnitudes 308 or metrics 310. Long short-term memory (LSTM) models can be used to capture temporal dependencies and trends in the electrical waveform data. The ML models 332 can be deployed to the edge device 301 for real-time prediction of electricity distribution events, such as EV charging events, industrial machinery turn on events, power generation events or any other events that can be detected using harmonics determined from. The ML framework 330 can facilitate the training and deployment of the ML models to allow for the system to adapt to changing electrical environments and loads.

ML model 332 can be any type and form of ML model trained to predict EV charging events. The ML model 332 can be trained using labeled datasets and feature vectors generated from harmonic magnitudes and statistical metrics. For example, the ML model 332 can include any one or more of (e.g., combination of) decision trees, neural networks, matched filters, transformer networks, or long short-term memory models. The ML model 332 can analyze feature vectors 314 to predict the probability of an EV charging event. The ML model 332 can be deployed to the edge device 301 for real-time prediction. The ML model 332 can be updated based on new data and receive updates from a remote data processing system. ML model 332 can output determinations (e.g., 602), such as predictions, that a particular electricity distribution event (e.g., EV charging event or any other) is taking place during the time period of the measurements 306. The ML model 332 can output the determination (e.g., output of the ML model) as the information or data to include into the notification 342.

ML trainer 334 can include any combination of hardware and software for training ML models. The ML trainer 334 can use labeled datasets and feature vectors to train ML models 332. For example, the ML trainer 334 can iteratively train models using additional or alternative labeled datasets and test the performance of the models via simulations. The ML trainer 334 can handle various types of ML techniques, such as decision trees, neural networks, and transformer networks. The ML trainer 334 can update models based on new data and deploy trained models to the edge device 301. The ML trainer 334 can allow for the ML models 332 to achieve a desired level of accuracy for predicting electricity distribution events (e.g., EV charging or other events occurring at the grid 100).

Notification function 340 can include any combination of hardware and software for transmitting notifications based on event probabilities. The notification function 340 can generate a notification 342 that includes, corresponds to, or is based on the determination or output of the ML model 332 utilized by the event determiner 320 to determine the event (e.g., event type) based on the event probability 322 satisfying a threshold 324. The notification function 340 can operate with event determiner 320 to determine the type of event detected (e.g., EV charging event, large industrial machinery activated event, power generation event from a solar or a wind farm or any other event). The notification function 340 can transmit a notification 342 when the event probability satisfies a threshold 324. For example, the notification function 340 can send a notification 342 to a remote data processing system to trigger operations related to electricity distribution. The notification function 340 can handle various types of notifications and communication protocols. The notification function 340 can ensure that the data processing system 150 receives timely and accurate information about EV charging events. The notification function 340 can be used for managing and supporting EV charging events, such as to cause the data processing system 150 to trigger one or more operations executors 360 to execute specific operations 362 impacting electricity distribution or use on the grid 100 or site 119.

Notification 342 can be any type and form of message transmitted to a remote data processing system. The notification 342 can include one or more instructions or commands for operations executors 360 on a data processing system 150. The notification 342 can be sent when the event probability satisfies a threshold 324. For example, the notification 342 can indicate that an EV charging event is occurring at the site 119. The notification 342 can trigger the data processing system 150 to execute any one or more operations 362 related to electricity distribution, such as controlling the delivery of power from a distributed energy resource, adjusting the charging rate of an EV, managing load balancing across the grid, initiating demand response programs, and optimizing power quality. The notification 342 can be transmitted using various communication protocols or techniques, such as such as Message Queuing Telemetry Transport (MQTT) for lightweight messaging, Hypertext Transfer Protocol (HTTP) for web-based communication, and WebSockets for real-time, bidirectional communication. The notification 342 can provide valuable information for managing and supporting EV charging events. The notification 342 can allow for the data processing system 150 to receive timely and accurate information.

Operations executor 360 can include any combination of hardware and software for executing operations 360 related to electricity distribution. The operations executor 360 can receive notifications 342 from the edge device 301, use information in notifications, such as type of event detected and trigger appropriate operations. For example, the operations executor 360 can control the delivery of power from a distributed energy resource, control the charging of the EV, impact a rate related to power, or impact power quality. The operations executor 360 can handle various types of operations and electrical environments. The operations executor 360 can ensure that the electricity distribution system responds effectively to EV charging events. The operations executor 360 can be crucial for managing and supporting EV charging events.

Operations 362 can be any type and form of actions executed by the operations executor 360. The operations 362 can be triggered by notifications 342 indicating the occurrence of electricity distribution events, such as EV charging events. For example, the operations 362 can include controlling the delivery of power from a distributed energy resource. The power delivered by the operation 362 can be set or configured based on the parameters or values (e.g., feature vector 314 or harmonics magnitudes 308 or metrics 310 indicative of the power or energy level sufficient to control the charging of the EV, impacting a rate related to power, or impacting power quality. For example, operations 362 can include adjusting the voltage levels to maintain grid stability during high demand periods. Operations 362 can involve activating or deactivating certain loads to balance the overall power consumption. Operations 362 can include managing the integration of renewable energy sources to optimize their contribution to the grid. The operations 362 can be executed based on the specific requirements of the site and the electrical environment. The operations 362 can ensure that the electricity distribution system responds effectively to EV charging events. The operations 362 can be crucial for managing and supporting EV charging events.

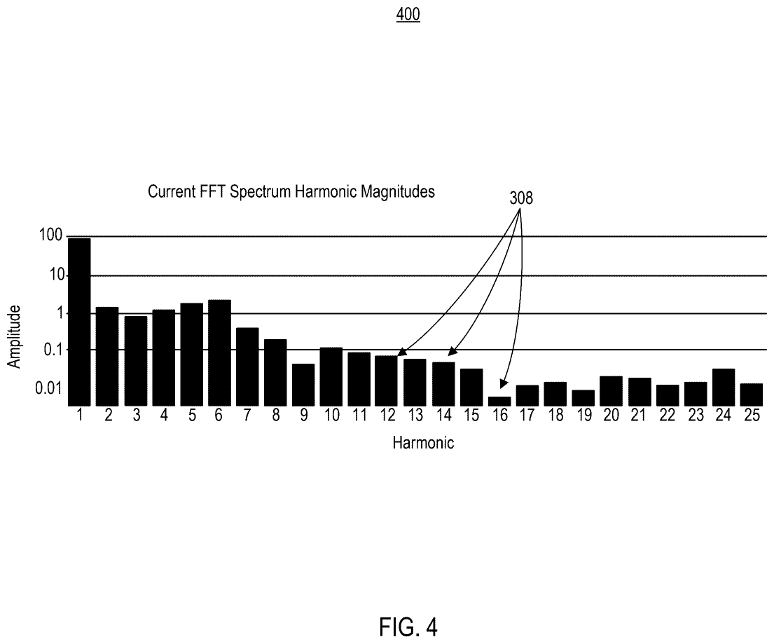

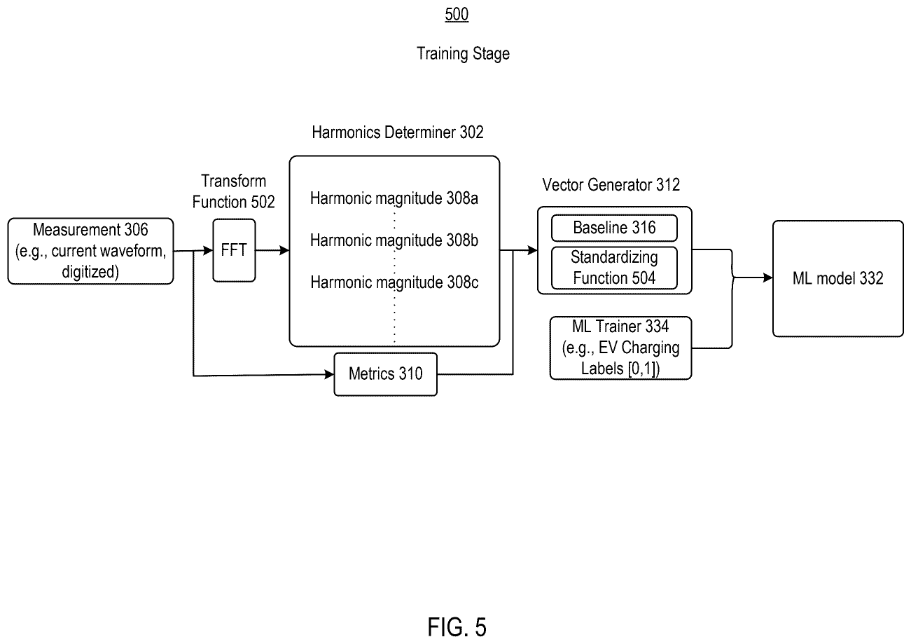

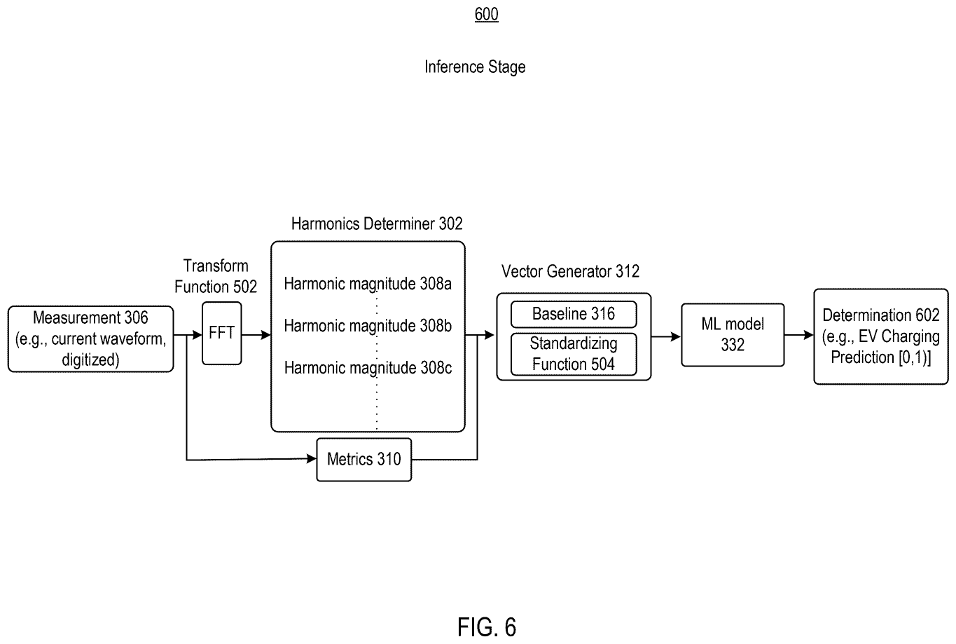

FIG. 4 illustrates a bar graph 400 of example current FFT spectrum harmonic magnitudes, in accordance with an implementation. The harmonic magnitude can sometimes be referred to as harmonic amplitude. The FFT spectrum harmonic magnitudes can be determined in connection with examples discussed in connection with FIG. 5 or 6. As shown, the graph 400 includes examples of harmonic orders from 1^{st} harmonic to 25^{th} harmonic. The edge device 301, which can be deployed on a metering device 118 or a metering system 201, can use any of the harmonic orders, including but not limited to those shown in FIG. 5, as part of the EV charging detection operations. Odd harmonic orders of FIG. 5 can include or refer to the odd multiples of the primary frequency (e.g., 1^{st} harmonic order or order 1). The primary frequency may be around 60 Hz. In this case, the harmonics can include the amplitudes of the odd multiple of 60 Hz, for example. Even harmonic orders of FIG. 6 can include or refer to the even multiples of the 2^{nd} harmonic order. In this case, the harmonics can include the amplitudes of the even multiple of 60 Hz, for example. In some cases, different utility grids may include differing primary frequencies, such as around 50 Hz, 55 Hz, or 65 Hz, to name a few.

A set of harmonic orders (e.g., sometimes referred to as a set of harmonics or a set of odd or even harmonics) can be part of various features utilized for EV charging detection. The set of harmonics can include one or more harmonic orders or arrangements of harmonic magnitudes 308 or any metrics 310. For the one or more harmonic orders to be a part of the set of harmonics, or harmonic magnitudes 308 can be correlated with electricity distribution events (e.g., EV charging events) and independent in characteristics (e.g., non-repeating) when compared to other harmonic orders. Being correlated with the EV charging events, or any other electricity distribution events, can include or involve changes to the harmonic magnitude in response to initiating EV charging or stopping the EV charging.

Having a harmonic order that is independent in characteristics can involve comparisons between the harmonic orders. For example, if the 7^{th} harmonic order magnitude is correlated with a particular type of an electricity charging event, such as the EV charging events, the 7^{th} harmonic order magnitude can be compared with other harmonic orders, e.g., other odd harmonic orders, or in some cases, even harmonic orders, among others. For any harmonic orders with similar characteristics to the 7^{th} harmonic order, e.g., similar increase or decrease or fluctuation in magnitude at the start, during, or at the end of the EV charging event, those harmonic orders may be filtered from the set of harmonics (or not included in the set of harmonics) to filter redundant features. In such cases, the harmonic orders in the set of harmonics can have varying characteristics from each other, based on the type of electricity distribution event. For instance, varying fluctuations and different or specific increase or decrease in harmonics magnitudes 308, or different characteristics (e.g., metrics 310) between at least one of the start of the EV charging, during the EV charging, or the end of the EV charging can be different based on the electricity distribution events and so can be indicative of an EV charging event.

In some cases, the set of harmonics can include predefined harmonics to be used for EV charging detection. In some configurations, the metering system 201 can determine or select one or more harmonics as part of the set of harmonics for EV charging detection. The metering system 201 or edge device 301 can select the order of magnitude based on a performance metric, e.g., which harmonic orders (e.g., a predefined number of harmonic orders) yield the highest score in the performance metric, indicative of the highest correlation between the harmonic orders and the EV charging event, or the harmonic orders most representative of EV charging events compared to other harmonic orders.

The metering system 201 can generate or store different sets of harmonics (e.g., different sets of features) for varying areas, charging infrastructures, etc. For example, the metering system 201 can include different sets of harmonics between a residential parking lot and public parking lot, EV and hybrid vehicle, L1, L2, and L3 type charging, weather conditions, the season in the year, time of day, etc. The different environment or situations relative to the EV charging can affect the performance of the harmonic orders to be used in predicting EV charging events. In some cases, the metering system 201 can receive information from the user (e.g., a client device) or from the operator, indicating at least one of but not limited to the type of vehicle using the charger, type of charging, or type of parking space. According to the received information, the metering system 201 can select a set of harmonic orders which can yield the highest performance given the various aspects relevant to the charging event. The metering system 201 may receive information relevant to the charging event from other devices, which can be used to select the set of harmonic orders. The set of harmonics may include a predefined number of harmonic orders, such as two harmonic orders, three harmonic orders, or four harmonic orders.

The metering system 201 (e.g., edge device 301) can compute, utilize or process any metrics 310, including any statistical metrics. For instance, the metering system 201 can compute the kurtosis of the electricity data (e.g., current waveform), the skewness to assess the asymmetry of the waveform, the standard deviation or variance to quantify the amount of variation or dispersion in the waveform, the mean absolute deviation based on measurements of the average absolute deviation from the mean of the waveform, the root mean square (RMS) value to assess the magnitude of the waveform, or any other statistical metrics.

The kurtosis (e.g., a statistical metric 310) can be a statistical measure indicative of the “tailedness” or the shape of the distribution of data, for instance, the heaviness or lightness of the tails compared to the normal distribution (e.g., in a bell curve). The statistical metric 310 (e.g., kurtosis) can measure or indicate whether the data points in a dataset tend to produce more outliers (e.g., extreme values or values around the positive or negative edges of the bell curve) than a normal distribution. In the context of electricity data, the metering system 201 can use the statistical metric 310 (e.g., the kurtosis) to analyze the shape of a signal distribution and detect anomalies, such as transient events, spikes, or irregularities, in the electrical signal (e.g., current data). For example, the metering system 201 can determine the kurtosis of the electrical signal to measure the frequency of occurrences of the extreme values (e.g., outliers) compared to a normal distribution. A relatively high kurtosis can indicate more extreme fluctuations (e.g., fluctuation of current measurements), and a low kurtosis can indicate a smoother, more stable signal (e.g., stable current measurements). The metering system 201 can use the statistical metric 310 (e.g., the kurtosis) to detect anomalies, such as current spikes, power surges, or other noises in the electrical signals. The kurtosis can be a part of the features for EV charging detection. For example, the features can include the set of harmonics and the kurtosis.

The metering system 201 can compute the harmonics and the statistical metric 310 (e.g., a kurtosis) over a predefined time period of data (e.g., 0.5 seconds, 1 second, 2 seconds). The predefined time period of data can be referred to as a window. The metering system 201 can output or generate a new time series (for each statistic, including the harmonics and the kurtosis) of features. The time-resolution of the time series can be the time difference between the consecutive windows of the waveform data. These windows can be adjacent or overlapping (e.g., data from one window may be included in the next one or more windows). For instance, a 1-second window with a 50% overlap can yield an output time series with time-resolution of 0.5 seconds. It should be noted that other types of metrics or statistics can be utilized herein, not limited to the harmonic orders and the kurtosis.

Referring to FIG. 5, in response to generating or acquiring measurements 306 (e.g., the time series of features), the metering system 201 (e.g., the edge device 301) can apply feature engineering functionalities of the harmonics determiner 302 to the features (e.g., the set of harmonics 308 and the metrics 310, such as the kurtosis) to prepare the data for events detection (e.g., EV charging detection). One or more techniques can be applied as part of the feature engineering, including at least one of but not limited to baselining or standardization. For baselining, the metering system 201 can determine or identify a predefined, relatively low (e.g., 20^{th}) percentile value of the features (over its entire time window), and subtract (or remove) the relatively low percentile value from that time series of the features, e.g., removing an approximated “baseline” of activity from the feature. For instance, EV charging events can draw relatively large amounts of current. As such, activities in the feature's values below the predefined percentile can be considered as non-charging periods (non-EV charging events).

The vector generator 312 can include or utilize a standardizing function 504 having any combination of hardware and software for removing outlier data or features indicative abnormal behavior from the measurements 306. For standardization, (e.g., using a standardizing function 504) the metering system 201 can divide the feature per site by a standard deviation. Dividing the feature per site by the standard deviation can indicate certain deviations from relatively normal behavior as compared to normal fluctuations present (e.g., baselines 316). In such cases, the standardizing function 504 of the metering system 201 can remove or filter at least a portion of the time series of features associated with the abnormal behavior, such as relatively significant deviations in one or more features. In some cases, the standardizing function 504 of the metering system 201 may determine the abnormal deviations using the kurtosis of the electricity (e.g., current) data or at least one harmonic magnitude.

Subsequent to the feature engineering provided via vector generator 312, the metering system 201 can utilize at least one suitable ML technique for training a model to perform a real-time EV-charging detection. The ML technique can include but is not limited to at least one of a decision tree, random forest, transformer, long short-term memory (LSTM), neural network, support vector machine (SVM), matched filter, k-nearest neighbor, or regression technique, among others. The metering system 201 can utilize the ML trainer 334 to train the ML model 332 using a labeled dataset (e.g., ground truth). The labeled dataset can include a plurality of timestamps, known periods of EV charging (e.g., labeled time periods when EV charging occurred), and the processed dataset (e.g., features after feature engineering). The known periods of EV charging can be represented as a first value (e.g., ‘1’) and the known periods of non-EV charging can be represented as a second value (e.g., ‘0’). The first and second values can be assigned to the timestamps. At least a portion of the processed dataset can be aligned with the occurrences of the EV charging. The metering system 201 can utilize the labeled dataset as input for training the model using ML.

FIG. 5 is a block diagram 500 illustrating an example EV detection training stage, in accordance with an implementation. The operations for training the model can be performed by one or more components or devices within the utility grid 100 or the systems 200 or 300 of FIGS. 2 and 3, such as the metering device 118 or the metering system 201 (e.g., edge device 301) at the grid edge. For example, the metering system 201 or an edge device 301, can obtain the digitized current waveform (e.g., electricity data or measurements 306). The metering system 201 included in an edge device 301, or vice versa, can utilize a transform function 502, that can operate together with one of the harmonics determiner 302 or vector generator 312, to perform one or more FFTs to obtain a plurality of harmonic magnitudes 308 (e.g., harmonic orders, including at least one of even harmonics or odd harmonics). The transform function 502 can perform any transformation of the measurements 306, such as FFT, Wavelet Transform for time-frequency analysis or Short-Time Fourier Transform (STFT) for analysis of non-stationary signals. A subset of the harmonic magnitudes 308 (e.g., 308a, 308b, 308c and so on) can be selected as part of the features for EV detection. The harmonic magnitudes 308 can be selected for determination or detection of an electricity distribution event (e.g., EV charging or discharging event) based on at least one of, but not limited to, one or more parameters, such as the location or site 119 of the EV charging, the type of car (e.g., EV or hybrid car), the type of EV charger, the type of parking space, etc. The metering system 201 or an edge device 301 can obtain the statistical metric 310 (e.g., a kurtosis) of the current waveform acquired from the measurements 306. The metering system 201 or the edge device 301 can perform feature engineering on the features (e.g., the selected harmonic magnitudes or orders and the statistical metric 310 such as the kurtosis). Performing the feature engineering can include baselining and standardization, for example. The metering system 201 or the edge device 301 may perform other types of feature engineering techniques, not limited to the baselining and standardization.

With the feature engineering performed on the features, the metering system 201 having an edge device 301 can provide the features and EV charging labels (e.g., ‘1’ and ‘0’ for EV charging event and non-EV charging event, respectively) as input to train a model using ML. The metering system 201 can iteratively train the model using additional or alternative labeled datasets. The metering system 201 can test the performance of the model via a simulation. For example, the metering system 201 can input processed data (e.g., feature engineered data) of a different dataset (not used during the training) to the model. The metering system 201 can obtain results from the model including a prediction of EV charging events, e.g., a value between ‘0’ and ‘1’ for individual timestamps or time windows. The metering system 201 can compare the results from the model with known time periods of EV charging to determine an accuracy of the model. Known time periods of EV charging can be obtained from an EV charging application that can be executed on the client device of the user, for example. In this case, the application can be in communication with the EV (sending indication of when the charging started or ended) or with the EV charger configured to provide an indication of when EV charging started or stopped, for example. In some cases, the known time periods can be recorded by an operator or the user. The metering system 201 may utilize the ML trainer 334 to iteratively train or re-train the ML model 332 to achieve a desired accuracy (e.g., performance or accuracy of the model at or above an accuracy threshold).

In some cases, after training the model, the metering system 201 can iteratively execute the ML model 332 using historical feature engineered data associated with the site and the ground truth (e.g. label data) to identify the optimal features to include for EV charging detection. For instance, individual sites can include varying EV charging environments, such that different features can be more representative of EV charging events than others. As such, the metering system 201 can iteratively find the optimal features to include for EV charging detection, such as by testing different combinations of features and comparing their performances (e.g., accuracies) in predicting the EV charging events.

FIG. 6 is a block diagram 600 illustrating an example EV detection inference stage, in accordance with an implementation. For the inference stage, the metering system 201 (e.g., including an edge device 301) can deploy the trained ML model (e.g., 332) for EV charging detection. The inference stage can be performed with new electricity data, such as using real-time or most recently updated measurements 306. For example, the metering system 201 can utilize the harmonics determiner 302, vector generator 312 and event determiner 320 to process the digitized current waveform. For instance, the metering system 201 can utilize a transform function 205 to perform FFT to obtain the harmonic magnitudes 308a-c and select from this plurality of harmonics 308, the harmonics 308 indicative of the event feature being identified. For instance, when the feature involves EV charging events, the harmonics determiner 302 can select, from the plurality of harmonics 308, only one or more of those harmonics 308 that indicate such a feature, based on the EV charging infrastructure associated with the metering system 201 (or the metering device 118), local to the EV charger. The harmonic magnitudes 308 or orders may be predefined by the user or the operator. The metering system 201 can obtain the statistical metric 310 (e.g., kurtosis) of the current waveform.

The metering system 201 (e.g., the edge device 301 of the metering system 201) can perform feature engineering (e.g., baselining and standardization) on the harmonic magnitudes 308 (e.g., 308a, 308b, 308c) and the statistical metric 310 (e.g., kurtosis) to obtain feature engineered data. The metering system 201 can provide the feature engineered data as an input to the trained model. Based on the features in the input data, the metering system 201 can obtain EV charging prediction, including a range of [0, 1]. In some configurations, the metering system 201 may obtain a value of one of ‘0’ or ‘1’ representing non-EV charging events and EV charging events, respectively. The output of the ML model 332 can output a determination 602, which can include any prediction or determination of occurrence of a particular electricity distribution event, (e.g., prediction of EV charging). The determination 602 can include or be assigned to the time stamps of the input (e.g., feature engineered) data and indicate the event taking place. In various configurations, the metering system 201 can detect EV charging event (if any) within one second of when EV charging has started (e.g., real-time detection). For instance, the edge device 301 can generate a determination of the electricity distribution event (e.g., determination of the ML model 332 indicating the EV charging event) within one or two seconds from the start of the event.

In some cases, the metering system 201 can receive a global model trained by one or more other metering systems or the data processing system 150. The global model may be deployed to one or more metering devices 118 (or metering systems). For purposes of providing examples, the data processing system 150 can generate, train, and store the global model. The data processing system 150 can broadcast the global model to one or more metering systems. The metering system 201 may fine tune the global model via iterative training and performing simulations to test accuracy of the model (e.g., using ground truth labels or datasets), for example. In some cases, the metering system 201 may send the fine tune version of the model to the data processing system 150 (or the cloud). In certain aspects, the data processing system 150 may integrate the locally fine tune model(s) into the model stored in the cloud (e.g., improve upon the local models).

The charging probability can be represented as a percentage. The charging probability may be instantaneously, continuously or constantly changing, due to various factors. The metering system 201 can transmit the resulting charging probability to the data processing system 150 or other devices capable of taking actions or managing the utility grid 100. In some cases, the metering system 201 may transmit the probability of EV charging occurrence in response to the probability being greater than or equal to a threshold, thereby reducing the data rate of network communication. Various actions can be performed in response to detecting the EV charging events, including at least one of but not limited to providing alert to the utility grid 100 of an EV charging event, controlling distributed energy resources (DERs), controlling charging capability of the EV, inform users when the EV is charging, automate utility equipment to support EV charging, manage power quality (e.g., increase utility power generation, regulate power distribution, or reduce or manage electrical consumption downstream, such as reducing EV charging speed), take preventative actions when EV charging is predicted to come online, etc.

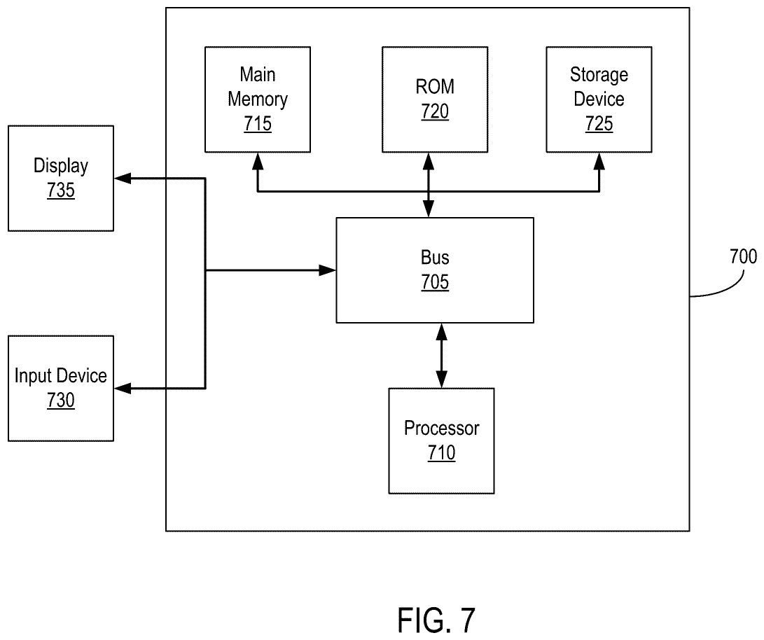

FIG. 7 is a block diagram of an example computer system 700. The computer system or computing device 700 can include or be used to implement the data processing system 150, the metering system 201, edge device 301, or any of its components. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can also be used for storing position information, utility grid data, command instructions, device status information, environmental information within or external to the utility grid, information on characteristics of electricity, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 may be coupled via the bus 705 to a display 735, such as a liquid crystal display, or active matrix display, for displaying information to a user such as an administrator of the data processing system or the utility grid. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 can be part of the data processing system 150, or other components of FIGS. 1-2, among others.

The processes, systems, and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

The technical solutions can involve numerous permutations and configurations. For example, the solutions can include a system, comprising: a metering system, comprising one or more processors and memory, located on a utility grid downstream from a substation to: receive high-resolution electrical data, generate a first plurality of statistics according to the high-resolution electrical data, train a ML model using the first plurality of statistics, and predict, using the trained machine learning model, an EV charging event based on a second plurality of statistics.

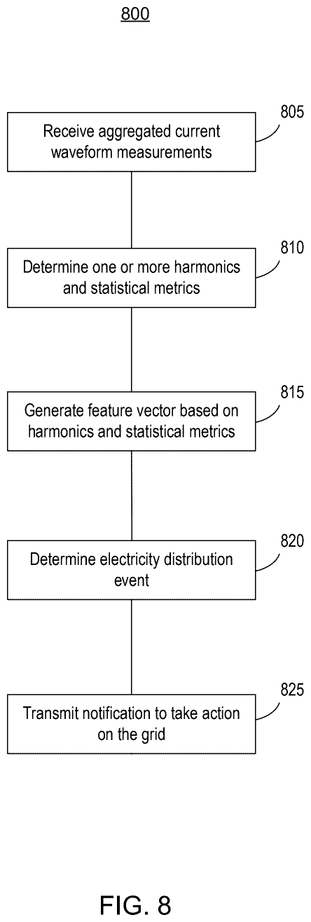

FIG. 8 illustrates an example flow diagram of a method 800 for real-time electricity distribution event detection. In some implementations, the method 800 is a method for real-time or near real-time (e.g., within 1-5 seconds) detection of EV charging events. The method 800 can be implemented using example systems, features and functionalities described in FIGS. 1-7. The method 800 can be implemented using one or more processors 710 configured via one or more instructions, data or computer code stored in one or more memories 715, 720 or 725, where the instructions data or computer code, when executed by the one or more processors 710, cause the one or more processors 710 to perform the acts of the method 800, such as acts 805-825. The method 800 can be implemented by an edge device 301 that is located at a site 119 electrically coupled with, or via, a distribution grid. The edge device 301 can include the one or more processors 710 coupled with memory 715 and configured (e.g., via instructions and data in memory 715) to perform the operations 805-825.

The method 800 can include the acts 805-825 that can be performed in any arrangement, order or sequence. In some implementations some acts 805-825 can be omitted, while in others, they can be implemented multiple times, depending on the design. At 805, the method can include receiving aggregated current waveform measurements. At 810, the method can include determining one or more harmonics and statistical metrics. At 815, the method can include generating a feature vector based on harmonics and statistical metrics. At 820, the method can include determining one or more electricity distribution events. At 825, the method can include transmitting notification to take action on the grid.

At 805, the method can include receiving aggregated current waveform measurements. The method can include receiving (e.g., by one or more processors of an edge device) a time series of aggregated current waveform measurements at the site. The time series can include timestamped measurements of current waveforms of the grid. For instance, the measurements can correspond to or capture the electrical current flowing through various loads at a site over time, providing a detailed record of how the current changes over time. The measurements can be taken using high-resolution sensors that sample the current at rates of 1-20 kHz, such as 10 kHz, recording even transient events or changes. The time series data can be aggregated from multiple sensors placed at different points in the grid to provide a comprehensive view of the electrical activity at the site. This aggregated data can then be analyzed to detect patterns and anomalies indicative of specific events, such as EV charging or the operation of heavy machinery.

The method can include a sensor generating the time series of aggregated current waveform measurements at a sample rate of at least 1 kHz, 5 kHz, 10 kHz, 15 kHz, 20 kHz, 50 kHz or 100 kHz. The time series of aggregated current waveform measurements can include current waveforms delivered to a plurality of different types of loads at the site. For example, the measurements can capture the electrical current flowing through residential appliances, industrial machinery, and renewable energy sources like solar panels and wind turbines. The comprehensive data collection can allow for accurate detection and analysis of various electricity distribution events.

At 810, the method can include determining one or more harmonics and statistical metrics. The method can include the edge device determining, based on the time series of aggregated current waveforms, a magnitude of one or more harmonics and a statistical metric. The method can utilize a waveform determiner using time stamped measurements of aggregated current waveforms to identify any number of harmonics (e.g., up to 5, 10, 15, 20, 25, 30, 50 or more than 50 harmonics). Harmonics can include, for example, any integer multiples of the fundamental frequency, such as the second, third, fourth, fifth and other harmonics (e.g., integer multiples of the primary frequency of the aggregated current waveform). Statistical metrics determined can include any measures of central tendency, such as mean or median, and measures of variability, such as standard deviation or variance. For example, the method can determine the mean magnitude of the third harmonic over a specified time period.

The method can include performing a transform on the time series of aggregated current waveforms to generate the one or more harmonics. The at least one of the one or more harmonics can include a primary frequency of 60 Hz, 50 Hz, and their corresponding harmonics (e.g., 120 Hz or 100 Hz for second harmonic, 240 Hz or 200 Hz for third harmonic, and so on). In some implementations, a count of the one or more harmonics utilized in the system is at least 3 (e.g., three harmonics).

The method can include the edge device generating one or more statistical metrics using Kurtosis. For example, the method can include the one or more processors of the edge device determining or measuring the sharpness of the peak of a frequency-distribution curve to identify transient events and anomalies in the current waveforms. By analyzing the kurtosis of the aggregated current waveforms, the edge device can detect unusual spikes or dips that may indicate particular electricity distribution events, such as the EV charging events.

At 815, the method can include generating a feature vector based on harmonics and statistical metrics. The method can include the edge device generating, based on a baseline established for the site, a feature vector based on the magnitude of the one or more harmonics and the statistical metric. For example, the edge device can generate a feature vector that includes a magnitude of the third harmonic and a standard deviation of the current waveform. For example, a feature vector can incorporate the mean magnitude of the fifth harmonic and the kurtosis of the waveform. The feature vectors can be used to train ML models to accurately detect EV charging events based on the unique electrical signatures they produce. For instance, a sudden increase in the magnitude of a third harmonic combined with a high kurtosis value might indicate the start of an EV charging session, or any other electricity distribution event.

The method can include the edge device determining the baseline based on a percentile value of a value of a feature for the site over the time window. The method can include generating the feature vector based on subtracting the baseline from an intermediary feature vector generated based on the magnitude of the one or more harmonics and the statistical metric. The method can include generating the feature vector based on dividing by a standard deviation of the value of the feature for the site. The feature vector can include a phase of the one or more harmonics, the magnitude of the one or more harmonics, and the statistical metric.

The method can include selecting features to include in the feature vectors based on a type of the site, wherein the type of the site is one of residential, commercial, urban, or rural. For example, the feature vector for a residential site can prioritize harmonics related to common household appliances, while a commercial site can focus on harmonics associated with industrial equipment. The method can include the feature vectors being tailored to particular event types or particular types of sites, allowing for different configurations based on the type of the site or the type of the events monitored.

At 820, the method can include determining one or more electricity distribution events. The method can include the edge device determining a probability of an electricity distribution event (e.g., that an EV is being charged) at the site during a time window corresponding to the time series of aggregated current waveform measurements. The method can include the edge device determining the probability of the event (e.g., EV charging event) using one or more models trained with ML. The event determiner of the edge device can receive one or more ML models from a data processing system and can utilize the ML models to determine probabilities of one or more events taking place, such as the EV charging event, based on the harmonics magnitudes, metrics or feature vectors or baselines input into one or more ML models.

The one or more models can be trained with ML. The one or more ML models can include at least one of, or any combination of, a decision tree, a neural network, a matched filter, a transformer network, or a long short-term memory model or functionality. The edge device can receive the one or more models from the data processing system located remote from the edge device. The edge device or the data processing system can update the one or more models based on the time series of aggregated current waveforms. When a data processing system updates the one or more ML models or data for the one or more ML models, the data processing system can transmit the updated one or more models or data to the data processing system to cause the data processing system to deploy a second one or more models trained based at least in part on the updated one or more models received from the edge device.

The edge device can determine, identify or detect an electricity distribution event (e.g., EV charging event) taking place, based on the measurements and the harmonic magnitudes and metrics determined from the measurements. The edge device can determine, identify or detect a particular electricity distribution event based on a comparison of the probability that the event took place during the time period of the measurements with a threshold for the given event. If the probability satisfies (e.g., exceeds) a threshold, the event determiner can determine or decide that the event has taken place, providing a determination or a prediction that the event took place at the site (e.g., EV charging has occurred or has begun during the time period of the measurements processed).

At 825, the method can include transmitting notification to take action on the grid. The method can include the edge device transmitting, based on a comparison of the probability with a threshold, a notification to a data processing system remote from the edge device to cause the data processing system to execute an operation related to distribution of electricity via the distribution grid. The method can include determining to transmit the notification based on the probability being greater than or equal to the threshold to indicate that the EV is being charged at the site. The notification can include the determination made by the edge device. The notification can include an instruction or data for an operations executor at a data processing system to trigger implementation of one or more operations at the data processing system.

The notification can trigger or initiate any number of operations at the data processing system in response to the electricity distribution event being determined, detected or identified from the aggregated waveform measurements. For example, a notification can trigger the operations executor to execute an operation for adjusting the power supply to balance a load on the grid. For example, the notification can include an instruction or data to trigger the controlling of the charging rate of the EV to prevent overloading the grid. For example, a notification can instruct the operations executor to activate a backup power source to support the increased demand. For example, the notification can trigger an operation to initiate a demand response program to reduce peak demand. For example, the notification can instruct the operations executor to optimize the distribution of renewable energy sources like solar and wind power to maintain grid stability.

The operation executed by the data processing system can include at least one of: an instruction to control delivery of power from a distributed energy resource, an instruction to control charging of the EV, an instruction to impact a rate related to power, or an instruction to impact power quality. For example, the operation can include adjusting the output of a solar panel array to match the increased demand from EV charging. For example, the operation can include reducing the charging rate of the EV to prevent overloading the grid during peak hours. For example, the operation can involve activating a battery storage system to supply additional power and maintain grid stability.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware- or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a Compact Disk Read-Only Memory (CD-ROM), a flash memory card, a Programmable Read-Only Memory (PROM), a RAM, a ROM, or a magnetic tape. In general, the computer-readable programs can be implemented in any programming language, such as List Processor (LISP), Practical Extraction and Reporting Language (PERL), C, C++, C #, Programmation en Logique (PROLOG), or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., a field programmable gate array (FPGA) or an application specific integrated circuit (ASIC). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC. Devices suitable for storing computer program instructions and data can include non-volatile memory, media and memory devices, including by way of example semiconductor memory devices, e.g., Erasable Programmable Read-Only Memory (EPROM), Electrically Erasable Programmable Read-Only Memory (EEPROM), and flash memory devices; magnetic disks, e.g., internal hard disks or removable disks; magneto optical disks; and CD ROM and Digital Versatile Disk Read-Only Memory (DVD-ROM) disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a LAN and WAN, an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system, comprising:
an edge device, comprising one or more processors coupled with memory, located at a site that receives electricity via a distribution grid, the edge device to:
receive a time series of aggregated current waveform measurements at the site that correspond to a plurality of different types of loads on current consumption at the site;
determine, based on the time series of aggregated current waveform measurements, a magnitude of one or more harmonics and a statistical metric;
generate, based on a baseline established for the site, a feature vector based on the magnitude of the one or more harmonics and the statistical metric;
determine, using one or more models trained with machine learning, a probability that an electric vehicle is being charged at the site during a time window corresponding to the time series of aggregated current waveform measurements; and
transmit, based on a comparison of the probability with a threshold, a notification to a data processing system remote from the edge device to cause the data processing system to execute an operation related to distribution of electricity via the distribution grid.

2. The system of claim 1, comprising:
a sensor to generate the time series of aggregated current waveform measurements at a sample rate of at least 10 kHz, wherein the time series of aggregated current waveform measurements includes current waveform measurements delivered to a plurality of different types of loads at the site.

3. The system of claim 1, wherein the edge device is further configured to:
perform a transform on the time series of aggregated current waveform measurements to generate the one or more harmonics, wherein at least one of the one or more harmonics comprises a primary frequency of 60 Hz.

4. The system of claim 3, wherein a count of the one or more harmonics is at least 3.

5. The system of claim 1, wherein the edge device is further configured to:
generate the statistical metric using Kurtosis.

6. The system of claim 1, wherein the edge device is further configured to:
determine the baseline based on a percentile value of a feature for the site over the time window; and
generate the feature vector based on subtracting the baseline from an intermediary feature vector generated based on the magnitude of the one or more harmonics and the statistical metric.

7. The system of claim 6, wherein the edge device is further configured to:
generate the feature vector based on dividing by a standard deviation of the value of the feature for the site.

8. The system of claim 1, wherein the feature vector comprises a phase of the one or more harmonics, the magnitude of the one or more harmonics, and the statistical metric.

9. The system of claim 1, wherein the one or more models are trained with machine learning comprises at least one of a decision tree, neural network, a matched filter, a transformer network, or long short-term memory.

10. The system of claim 1, wherein the edge device is further configured to:
receive the one or more models from the data processing system located remote from the edge device.

11. The system of claim 1, wherein the edge device is further configured to:
update the one or more models based on the time series of aggregated current waveform measurements; and
transmit the updated one or more models to the data processing system to cause the data processing system to deploy a second one or more models trained based at least in part on the updated one or more models received from the edge device.

12. The system of claim 1, wherein the edge device is further configured to:
select features to include in the feature vectors based on a type of the site, wherein the type of the site is one of residential, commercial, urban, or rural.

13. The system of claim 1, wherein the edge device is further configured to:
determine to transmit the notification based on the probability being greater than or equal to the threshold to indicate that the electric vehicle is being charged at the site.

14. The system of claim 1, wherein the operation executed by the data processing system comprises at least one of: an instruction to control delivery of power from a distributed energy resource, an instruction to control charging of the electric vehicle, an instruction to impact a rate related to power, or an instruction to impact power quality.

15. A method, comprising:
receiving, by an edge device comprising one or more processors coupled with memory, time series of aggregated current waveform measurements at a site that correspond to a plurality of different types of loads on current consumption at the site, wherein the edge device is located at the site that receives electricity via a distribution grid, the edge device to:
determining, by the edge device, based on the time series of aggregated current waveform measurements, a magnitude of one or more harmonics and a statistical metric;
generating, by the edge device, based on a baseline established for the site, a feature vector based on the magnitude of the one or more harmonics and the statistical metric;
determining, by the edge device, using one or more models trained with machine learning, a probability that an electric vehicle is being charged at the site during a time window corresponding to the time series of aggregated current waveform measurements; and
transmitting, by the edge device, based on a comparison of the probability with a threshold, a notification to a data processing system remote from the edge device to cause the data processing system to execute an operation related to distribution of electricity via the distribution grid.

16. The method of claim 15, comprising:
generating, by a sensor communicatively coupled with the edge device, the time series of aggregated current waveform measurements at a sample rate of at least 10 kHz, wherein the time series of aggregated current waveform measurements includes current delivered to a plurality of different types of loads at the site.

17. The method of claim 15, comprising:
generating, by the edge device, the statistical metric using Kurtosis.

18. The method of claim 15, comprising:
receiving, by the edge device, the one or more models from the data processing system located remote from the edge device;
updating, by the edge device, the one or more models based on the time series of aggregated current waveform measurements; and
transmitting, by the edge device, the updated one or more models to the data processing system to cause the data processing system to deploy a second one or more models trained based at least in part on the updated one or more models received from the edge device.

19. The method of claim 15, comprising:
selecting, by the edge device, features to include in the feature vectors based on a type of the site, wherein the type of the site is one of residential, commercial, urban, or rural.

20. A non-transitory computer-readable medium storing processor-executable instructions that, when executed by one or more processors, cause the one or more processors to:
receive a time series of aggregated current waveform measurements at a site that correspond to a plurality of different types of loads on current consumption at the site;
determine, based on the time series of aggregated current waveform measurements, a magnitude of one or more harmonics and a statistical metric;
generate, based on a baseline established for the site, a feature vector based on the magnitude of the one or more harmonics and the statistical metric;
determine, using one or more models trained with machine learning, a probability that an electric vehicle is being charged at the site during a time window corresponding to the time series of aggregated current waveform measurements; and
transmit, based on a comparison of the probability with a threshold, a notification to a data processing system remote from the one or more processors to cause the data processing system to execute an operation related to distribution of electricity via a distribution grid.
